(19) United States
(12) Patent Application Publication
(10) Pub. No.: US 2026/0079259 A1
(43) Pub. Date: Mar. 19, 2026

(54) REAL-TIME PRECISE IONOSPHERE CORRECTIONS FOR MOBILE DEVICES

(71) Applicant: Apple Inc., Cupertino, CA (US)

(72) Inventors: Erick SCHMIDT, San Jose, CA (US); Andrew J. KERNS, Cupertino, CA (US)

(21) Appl. No.: 18/885,147

(22) Filed: Sep. 13, 2024

(51) Int. Cl. G01S 19/07; G01S 19/37; H04L 69/16

(52) U.S. Cl. CPC G01S 19/072; G01S 19/37; H04L 69/16

(57) ABSTRACT

Described herein are solutions for real-time precise ionosphere corrections. An integrate and dump (I&D) server can receive a Networked Transport of Radio Technical Commission For Maritime Services (RTCM) via Internet Protocol (NTRIP) bit stream of a spherical harmonic model for precise point positioning (PPP). The model can be a vertical total electron content (VTEC) spherical harmonic expansion model and/or can include a set of ionosphere coefficients for correcting errors in satellite signals due to ionospheric conditions. The I&D server can generate a file of ionosphere coefficients, according to a refresh timer, and can send the file to a content delivery network (CDN) for distribution to user equipment (UEs) upon request. These and many other features and examples are described herein.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks can be developed to implement fifth generation (5G) or new radio (NR) technology, sixth generation (6G) technology, and so on. Such technology can include solutions for enabling user equipment (UE) and network devices, such as base stations and satellites, to communicate with one another.

### BRIEF DESCRIPTION OF THE DRAWINGS

The present disclosure will be readily understood and enabled by the detailed description and accompanying figures of the drawings. Like reference numerals can designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and can mean at least one, one or more, etc.

FIG. 1 is a diagram of an example overview of one or more of the techniques described herein.

FIG. 2 is a diagram of an example network according to one or more implementations described herein.

FIG. 3 is a diagram of an example of a precise point positioning (PPP) service providing precise correction coefficients based on ionosphere measurements according to one or more implementations described herein.

FIG. 4 is a diagram of an example of real-time precise ionosphere corrections for mobile devices according to one or more implementations described herein.

FIG. 5 is a diagram of an example of an integrate and dump (I&D) server according to one or more implementations described herein.

FIG. 6 is a diagram of an example of a process for generating an ionosphere file according to one or more implementations described herein.

FIG. 7 is a diagram of an example of a process for distributing an ionosphere file according to one or more implementations described herein.

FIG. 8 is a diagram of an example of a process for obtaining an ionosphere file according to one or more implementations described herein

FIG. 9 is a diagram of an example of components of a device according to one or more implementations described herein.

FIG. 10 is a diagram of example interfaces of baseband circuitry according to one or more implementations described herein.

FIG. 11 is a block diagram illustrating components, according to one or more implementations described herein, able to read instructions from a machine-readable or computer-readable medium (e.g., a non-transitory machine-readable storage medium) and perform any one or more of the methodologies discussed herein.

FIG. 12 is a diagram of an example process for real-time precise ionosphere corrections according to one or more implementations described herein.

FIG. 13 is a diagram of an example process for real-time precise ionosphere corrections according to one or more implementations described herein.

FIG. 14 is a diagram of an example process for real-time precise ionosphere corrections according to one or more implementations described herein.

### DETAILED DESCRIPTION

The following detailed description refers to the accompanying drawings. Like reference numbers in different drawings can identify the same or similar features, elements, operations, etc. Additionally, the present disclosure is not limited to the following description as other implementations can be utilized, and structural or logical changes made, without departing from the scope of the present disclosure.

Wireless communication networks can include user equipment (UE) capable of communicating with base stations and/or other network devices, such as satellites. The base stations can provide A UE with access to a core network (CN) and additional external networks, such as the Internet. Wireless communication networks can implement, or be connected to, non-terrestrial networks (NTNs) so that terrestrial network devices (e.g., UEs, base stations, etc.) can communicate with one another via non-terrestrial devices (e.g., low earth orbit (LEO) satellites, geostationary earth orbit (GEO) satellites, high earth orbit (HEO) satellites, etc.). Wireless communication networks can implement various techniques and standards that enable wireless communications to be reliable, efficient, and commensurate with any number of services being accessed.

Global Navigation Satellite Systems (GNSS) are reliable sources of positioning information available. GNSS satellites are, however, at a far distance from the Earth, which can expose GNSS signaling to several interferences when received at Earth. The margin for error for GNSS signals, in particular for signals of layer 5 (L5) frequency bands, can have a significant portion of error due to the ionosphere. L5 band signaling can include GPS L5 signals, Galileo E5a signals, BeiDou B2a signals, etc.

The ionosphere can include an ionized portion of the upper atmosphere of Earth, ranging from about 48 kilometers (km) or 30 miles (mi) to about 965 km or 600 mi above sea level. The ionosphere can include the thermosphere and parts of the mesosphere and exosphere. The ionosphere can be ionized by solar radiation, resulting in atmospheric electricity and forming an inner edge of the magnetosphere. The ionosphere can have practical importance because, among other functions, it can influence radio propagation to places on Earth and affect global positioning system (GPS) signals. Ionosphere can be referred to here simply as iono.

Precise point positioning can include a GNSS positioning technique that calculates geographic positions with a high degree of accuracy, having errors as small as a few centimeters under good conditions. PPP can be a combination of several sophisticated GNSS position refinement solutions that can be used with near-consumer-grade hardware to yield near-survey-grade results. PPP can use a single GNSS receiver, unlike standard real-time kinematic (RTK) positioning, which uses a temporarily fixed base receiver in the field as well as a relatively nearby mobile receiver.

Due to a frequency-selectivity property, the ionosphere effect can have up to 50% more impact on L5 bands when compared to conventional GPS layer 1 (L1) carrier acquisition (C/A) signaling. Navigation messages subjected to ionosphere correction techniques can mitigate up to 50% of this error. Accordingly, recent PPP services can provide for higher grade real-time or predicted ionosphere corrections delivered through standardized messages using, for example, Networked Transport of Radio Technical Commission For Maritime Services (RTCM) via Internet Protocol (NTRIP).

Dual-frequency receivers can compute the ionosphere effect by differencing pseudo-range equations and solving for the ionosphere delay in the so-called geometry-free solution. A pseudo-range can be the pseudo distance between a satellite and a satellite navigation receiver, such as a GPS receiver. To determine a position, a satellite navigation receiver can determine a distances associated with at least four satellites as well as their positions at time of transmitting. Positions can be calculated for any point in time based on the orbital parameters of the satellites. The pseudo-ranges of each satellite can be obtained by multiplying the speed of light by the time involved in the signal traveling from the satellite to the receiver. As there can be accuracy errors in the time measured, the term pseudo-range is used rather than range for such distances. This computation can require high-grade antennas and sophisticated filtering over extended periods of time for better results, making them unsuitable for mass-produced UEs (e.g., mobile devices). PPP ionosphere corrections over RTCM connections are therefore generally preferrable for such UEs

The inception of the NTRIP standards was based on low throughput channels such as Enhanced Data Rate For Global System for Mobile Communication (GSM) Evolution (GSM-EDGE), for real-time data streaming. Messages of the NTRIP standards are broken into streams of data that involve a continuous communication link with the transmission source. This feature can be unsuitable to UEs configured for sleep, idle, and/or other types of power saving modes of reduced activity. Additionally, UEs configured for more advanced communication standards, such as the 5th generation (5G) (e.g., new radio (NR)) communication standards of the 3rd generation partnership project (3GPP), are significantly faster such that data streaming is not required for the payload size of the NTRIP messages.

Further, with respect to the data content, the RTCM State Space Representation (SSR) standard defines the Ionosphere vertical total electron content (VTEC) messages using spherical harmonics expansions. A set of spherical harmonic coefficients (float values) describe a thin-shell global and continuous model of the ionosphere's VTEC. This allows a global and continuous “snapshot” model of the ionosphere which can also be applied to regional representation and multi-layered. The VTEC from the spherical harmonic expansion can be defined for thin TEC layers, and the values can be mapped to slant TEC (STEC) values using an elevation of the satellites at a height of a corresponding ionospheric layer transmitted in the SSR VTEC message. Investigation efforts on this data content reveal that a VTEC model can be applicable or otherwise effective for up to 2 hours. Said another way, a VTEC model can outperform other models or modeling techniques, such as the Klobuchar model, often used for GNSS navigation messaging.

The techniques described herein include solutions for real-time, highly precise ionosphere corrections for mobile devices. These techniques can leverage or accommodate one or more of the factors described above, such as increased throughput resulting from more advanced communication standards (e.g., 5G NR), power saving modes and capabilities of UEs, and longer ionosphere model effectiveness of VTEC modeling. As described herein, one or more servers can be used to precache NTRIP data streams, generate fully formed messages into files, and distributing the files to UEs. In particular, the ionosphere message contained therein can be configured as a N=16 degree, and M=16 order spherical harmonic expansions, with a total of 256 packed float coefficients (adjustable for precision). This can allow for forming a small assistance file (less than 2 KB) that can be refreshed every 3 minutes on a server-side, ensuring that the model remains current, while UEs can periodically download the file on-demand (e.g., every 1 hour) instead of continuously, to preserve battery power. This approach can be referred to as an “integrate and dump” (I&D) mechanism, where continuous NTRIP bit streams for PPP are collected and then dumped into a file for (asynchronous) mass distribution to UEs by a content delivery network (CDN).

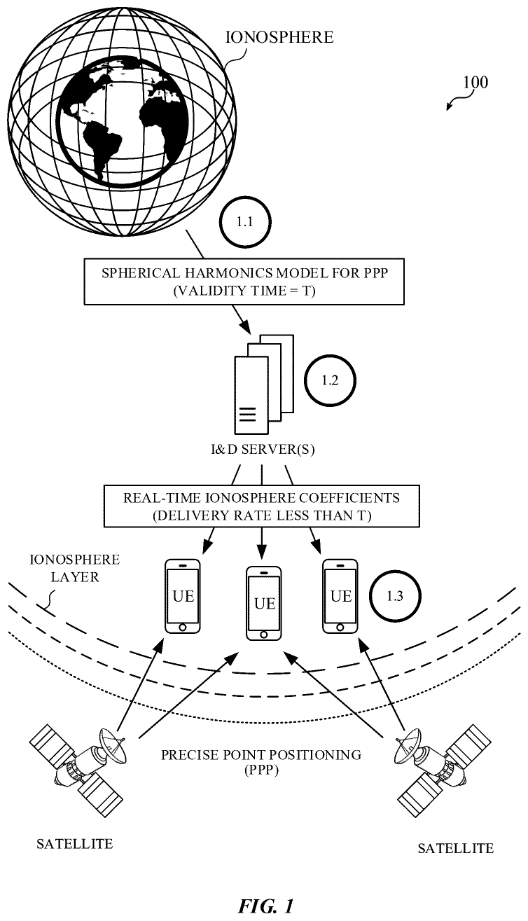

FIG. 1 is a diagram of an example overview 100 of one or more of the implementations described herein. As shown, overview 100 can include I&D servers, UEs, and satellites. The ionosphere around the earth can interfere with satellites signaling UEs. The I&D servers can receive an NTRIP bit stream of a spherical harmonic model for PPP (at 1.1). The model can be a VTEC spherical harmonic expansion model and/or can include a set of ionosphere coefficients for correcting interferences or errors in satellite signals due to current conditions of the ionosphere. The ionosphere coefficients can be for PPP via RTCM connections. The spherical harmonic model can be valid for correcting an amount of time T (e.g., 2 hours).

The I&D servers can process the NTRIP bit stream and generate a corresponding file that includes the ionosphere coefficients (at 1.2). The file can be referred to herein as an ionosphere coefficients file, an ionosphere file, an iono coeffects file, an iono file, a file, etc. In some scenarios, a file can also, or alternatively, refer to an assistance file for enhanced GPS (EGPS), which can include an ionosphere file. Enhanced GPS can enable UE 210 to determine a current location of UE 210 based on GPS signaling, non-GPS signaling (e.g., cellular and/or WiFi® signaling), or a combination thereof. Enhanced GPS can augment GPS signals to deliver faster location fixes, lower the cost of devices and components, and reduce power consumption and processing usage. An ionosphere file, as referred to herein, can include an ionosphere coefficients file.

The I&D servers can generate a new or updated file according to a refresh timer. The refresh timer can be three minutes or another specified period of time, such that the file consistently includes a current, accurate, or real-time set of ionosphere coefficients. While not shown, the I&D servers can provide ionosphere files to a CDN for distribution to the UEs. The ionosphere file can be delivered to the UE on-demand depending on UE internal requests, e.g. on a timer or upon user request.

The ionosphere file can be sent to the UEs (at 1.3). For example, the UEs can initiate a timer for periodically requesting updated ionosphere coefficients. The timer can be less than the validity time T of the spherical harmonic model. For instance, when the validity time T is two hours, the request timer can be one hour, or another period of time less than two hours. As the rate at which the I&D servers generate an updated ionosphere file (e.g., every three minutes) can be much shorter than the validity time T (e.g., 2 hours) and the request timer (e.g., 1 hour) or the push timer, the file received by the UEs can consistently include a current, accurate, or real-time set of ionosphere coefficients.

The UEs can use the updated ionosphere coefficients for PPP. For instance, the UEs can apply the ionosphere coefficients of the spherical harmonic model to correct for errors or other interference affecting signals from the satellites. As described above, the errors or other interference can be due to a current state of different layers of the ionosphere, which can vary according to geographic location. Additional examples of these and many other techniques, features, and implementations are described below with reference to the figures that follow.

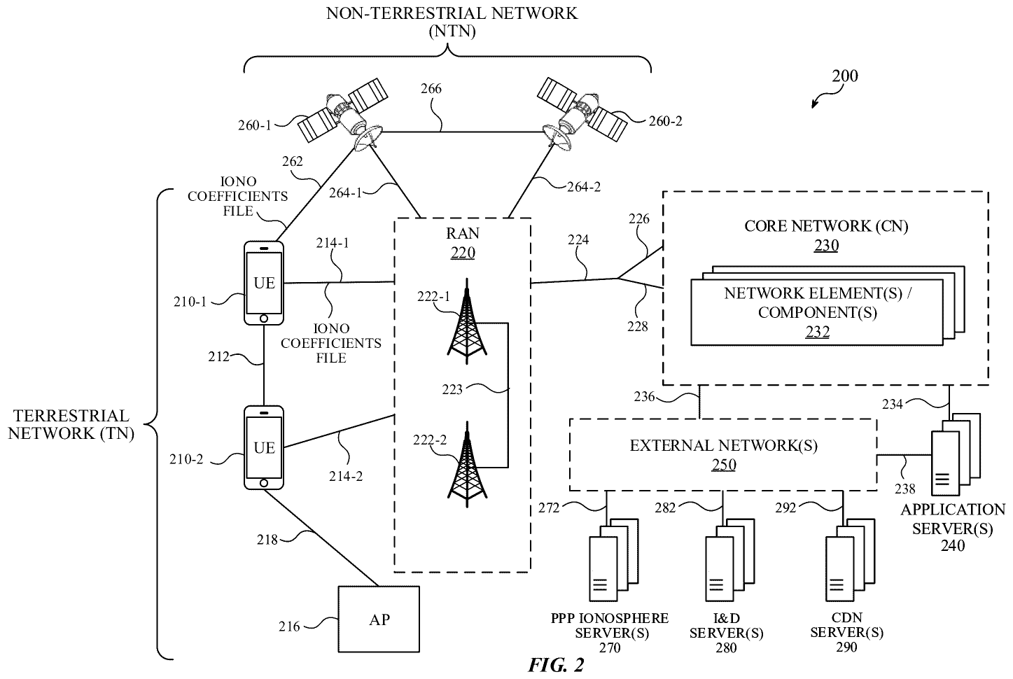

FIG. 2 is an example network 200 according to one or more implementations described herein. Example network 200 can include UEs 210-1, 210-2, etc. (referred to collectively as “UEs 210” and individually as “UE 210”), a radio access network (RAN) 220, a core network (CN) 230, application servers 240, external networks 250, and satellites 260-1, 260-2, etc. (referred to collectively as “satellites 260” and individually as “satellite 260”). As shown, network 200 can include a non-terrestrial network (NTN) comprising one or more satellites 260 (e.g., of a global navigation satellite system (GNSS)) in communication with UEs 210 and RAN 220.

The systems and devices of example network 200 can operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 200 can operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 210 can include smartphones (e.g., handheld touchscreen mobile computing devices connectable to one or more wireless communication networks). Additionally, or alternatively, UEs 210 can include other types of mobile or non-mobile computing devices capable of wireless communications, such as personal data assistants (PDAs), pagers, laptop computers, desktop computers, wireless handsets, etc. In some implementations, UEs 210 can include internet of things (IoT) devices (or IoT UEs) that can comprise a network access layer designed for low-power IoT applications utilizing short-lived UE connections. Additionally, or alternatively, an IoT UE can utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data can be a machine-initiated exchange, and an IoT network can include interconnecting IoT UEs (which can include uniquely identifiable embedded computing devices within an Internet infrastructure) with short-lived connections. In some scenarios, IoT UEs can execute background applications (e.g., keep-alive messages, status updates, etc.) to facilitate the connections of the IoT network.

UEs 210 can communicate and establish a connection with one or more other UEs 210 via one or more wireless channels 212, each of which can comprise a physical communications interface/layer. The connection can include an M2M connection, MTC connection, D2D connection, SL connection, etc. The connection can involve a PC5 interface. In some implementations, UEs 210 can be configured to discover one another, negotiate wireless resources between one another, and establish connections between one another, without intervention or communications involving RAN node 222 or another type of network node. In some implementations, discovery, authentication, resource negotiation, registration, etc., can involve communications with RAN node 222 or another type of network node.

UEs 210 can use one or more wireless channels 212 to communicate with one another. As described herein, UE 210 can communicate with RAN node 222 to request SL resources. RAN node 222 can respond to the request by providing UE 210 with a dynamic grant (DG) or configured grant (CG) regarding SL resources. A DG can include a grant based on a grant request from UE 210. A CG can involve a resource grant without a grant request and can be based on a type of service being provided (e.g., services that have strict timing or latency requirements). UE 210 can perform a clear channel assessment (CCA) procedure based on the DG or CG, select SL resources based on the CCA procedure and the DG or CG; and communicate with another UE 210 based on the SL resources. The UE 210 can communicate with RAN node 222 using a licensed frequency band and communicate with the other UE 210 using an unlicensed frequency band.

UEs 210 can communicate and establish a connection with RAN 220, which can involve one or more wireless channels 214-1 and 214-2, each of which can comprise a physical communications interface/layer. In some implementations, a UE can be configured with dual connectivity (DC) as a multi-radio access technology (multi-RAT) or multi-radio dual connectivity (MR-DC), where a multiple receive and transmit (Rx/Tx) capable UE can use resources provided by different network nodes (e.g., 222-1 and 222-2) that can be connected via non-ideal backhaul (e.g., where one network node provides NR access and the other network node provides either E-UTRA for LTE or NR access for 5G). A network node can be referred to herein as a base station 222. In such a scenario, one network node can operate as a master node (MN) and the other as the secondary node (SN). The MN and SN can be connected via a network interface, and at least the MN can be connected to the CN 230. Additionally, at least one of the MN or the SN can be operated with shared spectrum channel access, and functions specified for UE 210 can be used for an integrated access and backhaul mobile termination (IAB-MT). Similar for UE 210, the IAB-MT can access the network using either one network node or using two different nodes with enhanced dual connectivity (EN-DC) architectures, new radio dual connectivity (NR-DC) architectures, or the like. In some implementations, a base station (as described herein) can be an example of network node 222. In some scenarios, RAN 220 can coordinate with core network 230 via interfaces 224, 226, and/or 228.

In some scenarios, UE 210 can perform one or more operations enable collaborative estimation of UE locations. The operation(s) can include determining that UE 210 is moving with other UEs 210 and forming a group with the other UEs 210. Additionally, UEs 210 can determine their locations collaboratively, based on location information and/or location information metadata exchanged between UEs 210.

As shown, UE 210 can also, or alternatively, connect to access point (AP) 216 via connection interface 218, which can include an air interface enabling UE 210 to communicatively couple with AP 216. AP 216 can comprise a wireless local area network (WLAN), WLAN node, WLAN termination point, etc. The connection 216 can comprise a local wireless connection, such as a connection consistent with any IEEE 702.11 protocol, and AP 216 can comprise a wireless fidelity (Wi-Fi®) router or other AP. While not explicitly depicted in FIG. 2, AP 216 can be connected to another network (e.g., the Internet) without connecting to RAN 220 or CN 230. In some scenarios, UE 210, RAN 220, and AP 216 can be configured to utilize LTE-WLAN aggregation (LWA) techniques or LTE WLAN radio level integration with IPsec tunnel (LWIP) techniques. LWA can involve UE 210 in RRC_CONNECTED being configured by RAN 220 to utilize radio resources of LTE and WLAN. LWIP can involve UE 210 using WLAN radio resources (e.g., connection interface 218) via IPsec protocol tunneling to authenticate and encrypt packets (e.g., Internet Protocol (IP) packets) communicated via connection interface 218. IPsec tunneling can include encapsulating the entirety of original IP packets and adding a new packet header, thereby protecting the original header of the IP packets.

RAN 220 can include one or more RAN nodes 222-1 and 222-2 (referred to collectively as RAN nodes 222, and individually as RAN node 222) that enable channels 214-1 and 214-2 to be established between UEs 210 and RAN 220. RAN nodes 222 can include network access points configured to provide radio baseband functions for data and/or voice connectivity between users and the network based on one or more of the communication technologies described herein (e.g., 2G, 3G, 4G, 5G, WiFi, etc.). As examples therefore, a RAN node can be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 222 can include a roadside unit (RSU), a transmission reception point (TRxP or TRP), and one or more other types of ground stations (e.g., terrestrial access points). In some scenarios, RAN node 222 can be a dedicated physical device, such as a macrocell base station, and/or a low power (LP) base station for providing femtocells, picocells or the like having smaller coverage areas, smaller user capacity, or higher bandwidth compared to macrocells. A RAN node can generally be referred to herein as base station 222. Satellites 260 can operate as RAN nodes 222, with respect to UEs 210. As such, references herein to a base station, RAN node 222, etc., can involve implementations where the base station, RAN node 222, etc., is a terrestrial network (TN) node and also to implementation where the base station, RAN node 222, etc., is an NTN node (e.g., satellite 260).

Some or all of RAN nodes 222, or portions thereof, can be implemented as one or more software entities running on server computers as part of a virtual network, which can be referred to as a centralized RAN (CRAN) and/or a virtual baseband unit pool (vBBUP). In these implementations, the CRAN or vBBUP can implement a RAN function split, such as a packet data convergence protocol (PDCP) split wherein radio resource control (RRC) and PDCP layers can be operated by the CRAN/vBBUP and other Layer 2 (L2) protocol entities can be operated by individual RAN nodes 222; a media access control (MAC)/physical (PHY) layer split wherein RRC, PDCP, radio link control (RLC), and MAC layers can be operated by the CRAN/vBBUP and the PHY layer can be operated by individual RAN nodes 222; or a “lower PHY” split wherein RRC, PDCP, RLC, MAC layers and upper portions of the PHY layer can be operated by the CRAN/vBBUP and lower portions of the PHY layer can be operated by individual RAN nodes 222. This virtualized framework can allow freed-up processor cores of RAN nodes 222 to perform or execute other virtualized applications.

In some implementations, an individual RAN node 222 can represent individual gNB-distributed units (DUs) connected to a gNB-control unit (CU) via individual F1 or other interfaces. In such implementations, the gNB-DUs can include one or more remote radio heads or radio frequency (RF) front end modules (RFEMs), and the gNB-CU can be operated by a server (not shown) located in RAN 220 or by a server pool (e.g., a group of servers configured to share resources) in a similar manner as the CRAN/vBBUP. Additionally, or alternatively, one or more of RAN nodes 222 can be next generation eNBs (i.e., gNBs) that can provide evolved universal terrestrial radio access (E-UTRA) user plane and control plane protocol terminations toward UEs 210, and that can be connected to a 5G core network (5GC) 230 via an NG interface.

Any of the RAN nodes 222 can terminate an air interface protocol and can be the first point of contact for UEs 210. In some implementations, any of the RAN nodes 222 can fulfill various logical functions for the RAN 220 including, but not limited to, radio network controller (RNC) functions such as radio bearer management, uplink and downlink dynamic radio resource management and data packet scheduling, and mobility management. UEs 210 can be configured to communicate using orthogonal frequency-division multiplexing (OFDM) communication signals with each other or with any of the RAN nodes 222 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals can comprise a plurality of orthogonal subcarriers.

In some implementations, a downlink resource grid can be used for downlink transmissions from any of the RAN nodes 222 to UEs 210, and uplink transmissions can utilize similar techniques. The grid can be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements (REs). Each resource block can comprise a collection of resource elements; in the frequency domain, this can represent the smallest quantity of resources that currently can be allocated. There are several different physical downlink channels that are conveyed using such resource blocks.

Further, RAN nodes 222 can be configured to wirelessly communicate with UEs 210, and/or one another, over a licensed medium (also referred to as the “licensed spectrum” and/or the “licensed band”), an unlicensed shared medium (also referred to as the “unlicensed spectrum” and/or the “unlicensed band”), or combination thereof. A licensed spectrum can correspond to channels or frequency bands selected, reserved, regulated, etc., for certain types of wireless activity (e.g., wireless telecommunication network activity), whereas an unlicensed spectrum can correspond to one or more frequency bands that are not restricted for certain types of wireless activity. Whether a particular frequency band corresponds to a licensed medium or an unlicensed medium can depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 210 and the RAN nodes 222 can operate using stand-alone unlicensed operation, licensed assisted access (LAA), enhanced LAA (eLAA), and/or further eLAA (feLAA) mechanisms. In such implementations, UEs 210 and the RAN nodes 222 can perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations can be performed according to a listen-before-talk (LBT) protocol.

The PDSCH can carry user data and higher layer signaling to UEs 210. The physical downlink control channel (PDCCH) can carry information about the transport format and resource allocations related to the PDSCH channel, among other things. The PDCCH can also inform UEs 210 about the transport format, resource allocation, and hybrid automatic repeat request (HARQ) information related to the uplink shared channel. Typically, downlink scheduling (e.g., assigning control and shared channel resource blocks to UE 210 within a cell) can be performed at any of the RAN nodes 222 based on channel quality information fed back from any of UEs 210. The downlink resource assignment information can be sent on the PDCCH used for (e.g., assigned to) each of UEs 210.

One or more of the techniques described herein can UE 210 to monitor UL traffic of an application or wireless link, detect an increase in UL traffic, and communicate with the network (e.g., base station 222, satellite 260, etc.,) to dynamically increase UL resources. The increase in UL resource can include a change in the number of UL slots per frame. In doing so, UE 210 can determine the UL requirements of the application, assess a current usage of UL resources, and more. For example, UE 210 can verify that DL resources are underused, before requesting an increase in UL resource. UL performance can thus be increased without a meaningful decrease in DL performance, as the increase in UL resources can be achieved by a decrease DL resources. Dynamically increasing the UL resources can enable the UE to improve UL performance commensurate with the requirements or preferences of applications that generate significant UL traffic, engage in edge compute offloading (e.g., application servers 240), and more. Many other aspects and examples are also described herein.

The RAN nodes 222 can be configured to communicate with one another via interface 223. In implementations where the system is an LTE system, interface 223 can be an X2 interface. In NR systems, interface 223 can be an Xn interface. The X2 interface can be defined between two or more RAN nodes 222 (e.g., two or more eNBs/gNBs or a combination thereof) that connect to evolved packet core (EPC) or CN 230, or between two eNBs connecting to an EPC. In some implementations, the X2 interface can include an X2 user plane interface (X2-U) and an X2 control plane interface (X2-C). The X2-U can provide flow control mechanisms for user data packets transferred over the X2 interface and can be used to communicate information about the delivery of user data between eNBs or gNBs. For example, the X2-U can provide specific sequence number information for user data transferred from a master eNB (MeNB) to a secondary eNB (SeNB); information about successful in sequence delivery of PDCP packet data units (PDUs) to a UE 210 from an SeNB for user data; information of PDCP PDUs that were not delivered to a UE 210; information about a current minimum desired buffer size at the SeNB for transmitting to the UE user data; and the like. The X2-C can provide intra-LTE access mobility functionality (e.g., including context transfers from source to target eNBs, user plane transport control, etc.), load management functionality, and inter-cell interference coordination functionality.

As shown, RAN 220 can be connected (e.g., communicatively coupled) to CN 230. CN 230 can comprise a plurality of network elements 232, which are configured to offer various data and telecommunications services to customers/subscribers (e.g., users of UEs 210) who are connected to the CN 230 via the RAN 220. In some implementations, CN 230 can include an evolved packet core (EPC), a 5G CN (5GC), and/or one or more additional or alternative types of CNs. The components of the CN 230 can be implemented in one physical node or separate physical nodes including components to read and execute instructions from a machine-readable or computer-readable medium (e.g., a non-transitory machine-readable storage medium). In some implementations, network function virtualization (NFV) can be utilized to virtualize any or all the above-described network node roles or functions via executable instructions stored in one or more computer-readable storage mediums (described in further detail below).

A logical instantiation of the CN 230 can be referred to as a network slice, and a logical instantiation of a portion of the CN 230 can be referred to as a network sub-slice. Network function virtualization (NFV) architectures and infrastructures can be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

As shown, CN 230, application servers 240, and external networks 250 can be connected to one another via interfaces 234, 236, and 238, which can include IP network interfaces. Application servers 240 can include one or more server devices or network elements (e.g., virtual network functions (VNFs) offering applications that use IP bearer resources with CN 230 (e.g., universal mobile telecommunications system packet services (UMTS PS) domain, LTE PS data services, etc.). Application servers 240 can also, or alternatively, be configured to support one or more communication services (e.g., voice over IP (VoIP sessions, push-to-talk (PTT) sessions, group communication sessions, social networking services, etc.) for UEs 210 via the CN 230. Similarly, external networks 250 can include one or more of a variety of networks, including the Internet, thereby providing the mobile communication network and UEs 210 of the network access to a variety of additional services, information, interconnectivity, and other network features.

Satellites 260 can communicate with UEs 210 via service link or wireless interface 262 and/or RAN 220 via feeder links or wireless interfaces 264 (depicted individually as 264-1 and 264-2). In some implementations, satellite 260 can operate as a passive or transparent network relay node regarding communications between UE 210 and the terrestrial network (e.g., RAN 220). In some implementations, satellite 260 can operate as an active or regenerative network node such that satellite 260 can operate as a base station to UEs 210 (e.g., as a base station of RAN 220). In some implementations, satellites 260 can communicate with one another via a direct wireless interface (e.g., 266) or an indirect wireless interface (e.g., via RAN 220 using interfaces 264-1 and 264-2).

Additionally, or alternatively, satellite 260 may include a GEO satellite, LEO satellite, or another type of satellite. Satellite 260 may also, or alternatively pertain to one or more satellite systems or architectures, such as a global navigation satellite system (GNSS), global positioning system (GPS), global navigation satellite system (GLONASS), BeiDou navigation satellite system (BDS), etc. In some implementations, satellites 260 may operate as bases stations (e.g., RAN nodes 222) with respect to UEs 210. As such, references herein to a base station, RAN node 222, etc., may involve implementations where the base station, RAN node 222, etc., is a terrestrial network node and implementation, where the base station, RAN node 222, etc., is a non-terrestrial network node (e.g., satellite 260). As described herein, UE 210 and base station 222 may communicate with one another, via interface 214, to enable enhanced power saving techniques.

PPP ionosphere servers 270 can communicate with external networks 250 via interface 272, which can include one or more IP network interfaces. PPP ionosphere servers 270 can include one or more server devices or network elements (e.g., virtual network functions (VNFs)). PPP ionosphere servers 270 can receive, process, store, and communicate data and other types of information. PPP ionosphere servers 270 can provide a PPP ionosphere service that can generate a model of a state of the ionosphere based on measurements and other types of information. The model can include a set of spherical harmonic coefficients (e.g., float values) that represent the Ionosphere VTEC. PPP ionosphere servers 270 can generate an ionosphere message that includes the model, which can be based on the RTCM and the SSR communication standards. The model can be communicated via interface 272 as an NTRIP bit stream. In some implementations, PPP ionosphere servers 270 can communicate directly with CN 230 (instead of via external networks 250).

I&D servers 280 can communicate with external networks 250 via interface 282, which can include one or more IP network interfaces. I&D servers 280 can include one or more server devices or network elements (e.g., virtual network functions (VNFs)). I&D servers 280 can receive, process, store, and communicate data and other types of information. I&D servers 280 can receive an NTRIP bit stream via interface 280 and can generate a file of ionosphere coefficients. I&D servers 280 can communicate the file to CDN servers 290 for distribution. I&D servers 280 can generate files of ionosphere coefficients according to a schedule (e.g., once every 3 minutes) and/or in response to one or more conditions, commands, requests, or triggers. In some implementations, I&D servers 280 can communicate directly with CN 230 (instead of via external networks 250).

CDN servers 290 can communicate with external networks 250 via interface 292, which can include one or more IP network interfaces. CDN servers 290 can include one or more server devices or network elements (e.g., virtual network functions). CDN servers 290 can receive, process, store, and communicate data and other types of information. CDN servers 290 can be configured to receive, store, and distribute files of ionosphere coefficients. CDN servers 290 can distribute the files to UEs 210 according to a predetermined schedule and/or in response to one or more conditions, commands, requests, or triggers. The files can be distributed via satellites 260, RAN 220, AP 216, and/or one or more other types of network access points. In some implementations, CDN servers 290 can communicate directly with CN 230 (instead of via external networks 250). CDN servers 290 can operate based on a request/response system using uniform resource locator (URL) hypertext transfer protocol (HTTP). CDN servers 290 can receive a request from UE 210 for an assistance file for enhanced GPS, and CDN servers 290 can respond by sending the assistance file for enhanced GPS to UE 210. The assistance file for enhanced GPS can include the ionosphere file.

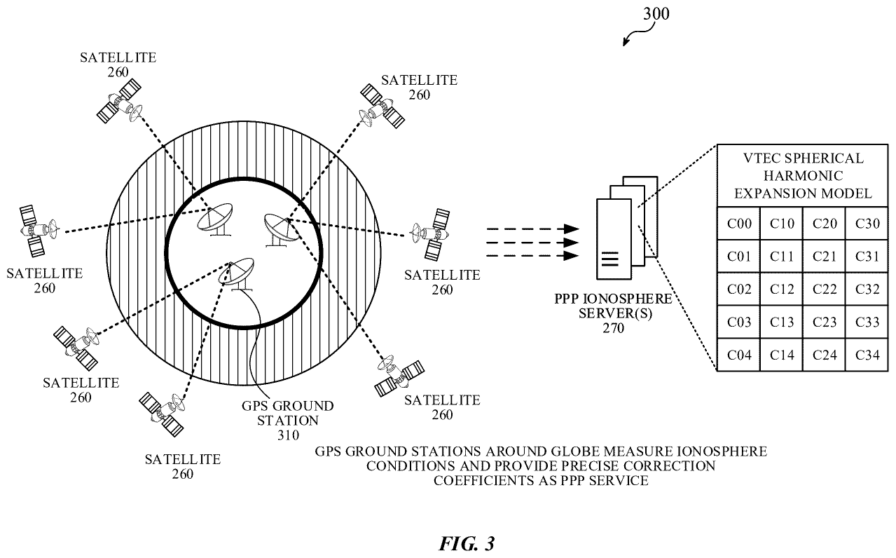

FIG. 3 is a diagram of an example 300 of a PPP service providing precise correction coefficients based on ionosphere measurements according to one or more implementations described herein. As shown, example 300 can include GPS ground stations 310 positioned around the globe (e.g., the Earth). GPS ground stations 310 can monitor and measure one or more characteristics of satellites 260 and/or signals from satellites 260. Satellites 260 can be high earth orbit satellites or another type of satellite. The measurements can be provided and processed by PPP ionosphere servers 270 to produce precise correction coefficients as a PPP service. While not shown, PPP ionosphere servers 270 can generate an NTRIP bit stream that can be sent to one or more devices as described herein.

The precise correction coefficients can include, or be used, to generate an ionosphere VTEC spherical harmonic expansion model representing the current or measured ionospheric conditions. One or more events or phenomena that can affect global ionospheric conditions, regional ionospheric conditions, and/or ionosphere-layer-specific conditions (e.g., the D layer, E layer, or F layer). Examples of such phenomena can include climate anomalies, equatorial anomalies, solar intensity, geomagnetic disturbances, radio communications, weather patterns, lightning, polar cp absorption, X-rays, solar flares, coronal mass ejections (CMEs), and more can affect global and/or regional ionospheric conditions. Varying conditions can result in different Ionosphere VTEC values for correcting for the ionospheric conditions from the real-time model.

Ionosphere VTEC can be provided using spherical harmonic expansions that can allow a global and continuous model of the ionosphere but can also be applied to regional representation. The spherical harmonic expansion can be a first constituent of a multiple stage ionosphere correction or correction procedure for a thin-shell ionosphere model. The VTEC values from the spherical harmonic expansion can include infinitesimally thin TEC layers, where values can be mapped to slant TEC (STEC) values using an elevation of satellites at a height of the corresponding ionospheric layer transmitted in the SSR VTEC message.

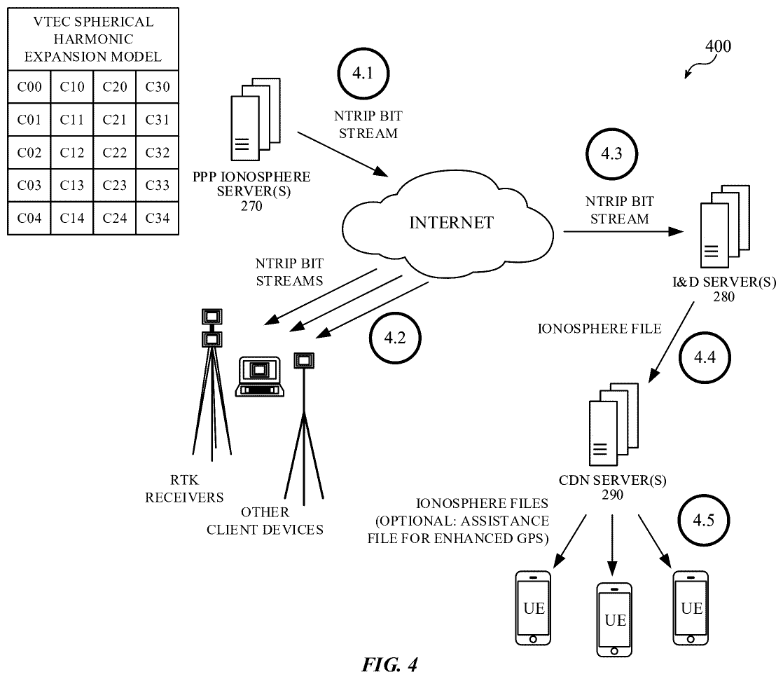

FIG. 4 is a diagram of an example of real-time precise ionosphere corrections for mobile devices according to one or more implementations described herein. As shown, PPP ionosphere servers 270 can communicate a VTEC spherical harmonic expansion model as an NTRIP bit stream (at 4.1). The NTRIP bit stream can be sent via the Internet, or another type of network, to RTK receivers or other client devices with RTK capabilities (at 4.2). An RTK-capable device can use an RTK receiver to determine real-time kinematic (RTK) positioning based on a temporarily fixed position.

The NTRIP bit stream can be sent via the Internet, or another type of network, to I&D servers 280 (at 4.3). I&D servers 280 can generate an ionosphere file based on the NTRIP stream. I&D servers 280 can communicate the file to CDN servers 290 for distribution (at 4.4). I&D servers 280 can generate and communicate an ionosphere file of ionosphere coefficients according to a specified timer or schedule. The timer can be a refresh time, and the duration of the time can be 3 minutes or another duration. In some implementations, I&D servers 280 can generate and/or communicate ionosphere files in response to one or more conditions, commands, requests, or triggers.

CDN servers 290 can be configured to receive, store, and distribute ionosphere files to UE 210 (at 4.5). CDN servers 290 can receive a request from one or more UEs 210, and in response to the request, communicate a copy of the ionosphere file to the requesting UE 210. The ionosphere file can include the VTEC spherical harmonic expansion model generated by PPP ionosphere servers 270. The VTEC spherical harmonic expansion model can include ionosphere coefficients that can be used to correct adjust for or otherwise correct errors in signaling to or from satellites 260. The ionosphere files can be distributed via the Internet or another type of wired network, a wireless network, and/or one or more types of satellite networks. In some implementations, ionosphere files can be included in an assistance file for enhanced GPS services.

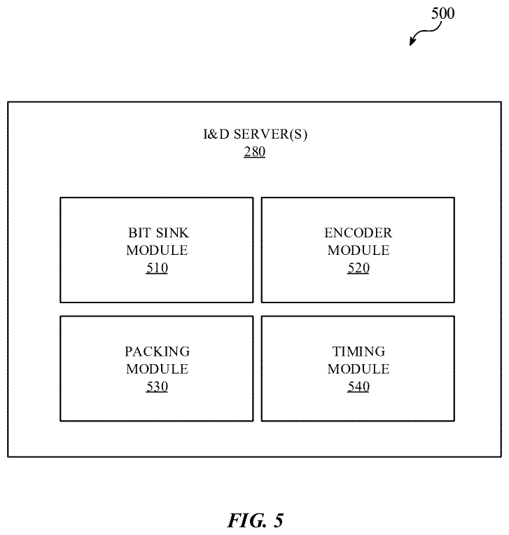

FIG. 5 is a diagram of an example of I&D server 280 according to one or more implementations described herein. As shown, I&D server 280 can include bit sink module 510, encoder module 520, packing module 530, and timing module 540. A module can include hardware, software, or a combination of hardware and software. Examples of the hardware can include a memory device and one or more processors. The memory device can store instructions that are executable by the one or more processors. In some implementations, I&D server 280 can include one or more additional, fewer, alternative, or alternatively arranged modules than shown in FIG. 5.

Bit sink module 510 can be configured to receive and store (or buffer) NTRIP bits used to communicate a VTEC spherical harmonic expansion model generated by PPP ionosphere servers 270. Bit sink module 510 can include a maximum or threshold storage capacity. When the maximum or threshold storage capacity is reached, bit sink module 510 can be configured to dump or remove some or all of the NTRIP bits stored by sink module 510. In some implementations, bit sink module 510 can include a timer for storing NTRIP bits. Bit sink module 510 can initiate a storage timer upon receiving NTRIP bits and can dump or delete the NTRIP bits upon expiration of the storage timer.

Encoder module 520 can be configured to encode NTRIP bits received by bit sink module 510. Encoding the NTRIP bits can enhance security and/or prepare the NTRIP bits for packing or compression by packing module 530. Encoder module 520 and/or packing module 530 can generate an ionosphere file that can include ionosphere coefficients of a VTEC spherical harmonic expansion model generated by PPP ionosphere servers 270. Timing module 540 can include a refresh timer. The refresh timer can be initiated when the ionosphere file is communicated by I&D server 280 to CDN servers 290. In some implementations, the refresh timer can be initiated in response to one or more additional, or alternative, triggers or conditions, such as when NTRIP bits are received and/or when the ionosphere file is generated.

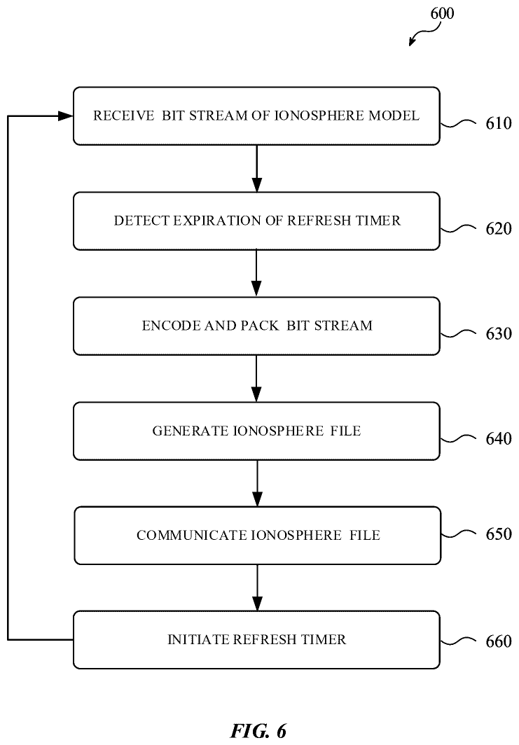

FIG. 6 is a diagram of an example of a process 600 for generating an ionosphere file according to one or more implementations described herein. An ionosphere file can include the ionosphere coefficients derived from measurements of ionosphere conditions. As shown, process 600 can be implemented by I&D server 280. In some implementations, some or all of process 600 can be performed by one or more other systems or devices, including one or more of the devices of FIG. 2. Additionally, process 600 can include one or more fewer, additional, differently ordered and/or arranged operations than those shown in FIG. 6. In some implementations, some or all of the operations of process 600 can be performed independently, successively, simultaneously, etc., of one or more of the other operations of process 600. As such, the techniques described herein are not limited to the number, sequence, arrangement, timing, etc., of the operations or processes depicted in FIG. 6.

As shown, process 600 can include receiving bit stream (block 610). For example, I&D server 280 can receive a bit stream from PPP ionosphere servers 270. The bit stream can be an NTRIP bit stream. The bit stream can include ionosphere coefficients are derived from measurements of ionosphere conditions. The ionosphere coefficients can be of a VTEC spherical harmonic expansion model. The spherical harmonic expansion model can be associated with a validity time that includes an amount of time for which the ionosphere coefficients can be used to correct for the errors in the satellite signals (such as 2 hours).

Process 600 can include detecting an expiration of a refresh timer (block 620). For example, I&D server 280 can monitor a refresh timer initiated in response to one or more triggers, conditions, or events. Examples of triggers, conditions, or events can include reception of a threshold number of bits, stored bits occupying a threshold amount of memory, generating or communicating an ionosphere file, and more.

Process 600 can include encoding and packing the bit stream (block 630). For example, I&D server 280 can encode and pack the bit stream. The bit stream can be encoded using one or more types of encoders and packing the encoded bit stream can include compressing the bit stream. Process 600 can include generating an ionosphere file (block 640). For example, I&D server 280 can generate an ionosphere file. The ionosphere file can include the encoded bit stream packed into a compressed file. Process 600 can include communicating the ionosphere file (block 650). For example, I&D server 280 can communicate the ionosphere file to CDN servers 290.

Process 600 can include initiating a refresh timer (block 660). For example, I&D server 280 can initiate a refresh timer. In some implementations, I&D server 280 can initiate (or re-initiate) the refresh timer in response to generating or communicating the ionosphere file. The refresh timer can be less than a request timer of UE and less than a validity time of a VTEC spherical harmonic expansion model. For example, the refresh timer can be 3 minutes or less, the request timer can be 1 hour or less, and the validity time of the VTEC spherical harmonic expansion model can be more than 1 hour (e.g., 2 hours). As shown, process 600 can including returning to receiving a bit stream of an ionosphere model (block 610).

While not shown, process 600 can also include dynamically adapting or modifying the refresh timer. This can include I&D servers 280 measuring, detecting, or determining one or more factors, triggers, or conditions, and increasing or decreasing the refresh timer in repones to the trigger or condition. Examples of such triggers or conditions can include whether I&D server 280 continues to receive a consistent or on-schedule bit stream from the PPP ionosphere servers 270. For example, I&D servers 280 can increase, delay, or pause the refresh timer in response to the bit stream no longer arriving, the bit stream arriving to slowly, and/or receiving an incomplete bit stream. In another example, CDN servers 290 can monitor a rate or quantity of request for ionosphere coefficient files from UEs 210 and can report the rate or quantity of requests to I&D servers 280.

Based on the rate or quantity of requests, I&D servers 280 can increase or decrease the length of the refresh timer. When the rate of requests is below a given threshold, I&D servers 280 can increase the refresh rate timer, whereas when the rate of requests is about the threshold, or about another threshold, I&D servers 280 can decrease the refresh rate timer. In some implementations, CDN servers 290 can determine an appropriate refresh timer (or an appropriate change to a current refresh timer) and can send I&D servers 280 instructions that cause I&D servers 280 to set or modify the refresh timer accordingly.

In another example, the refresh rate timer can be synchronized with the delivery of a threshold number of ionosphere coefficients, which can be less than or equal to the number of ionosphere coefficients for a complete VTEC spherical harmonic expansion model. Accordingly, I&D servers 280 can increase or decrease the length of the refresh timer based on one or more factors, triggers, or conditions. In some implementations, I&D servers 280 can modify the refresh timer based on a variance or variability of the VTEC spherical harmonic expansion models or the variance or variability of the ionosphere coefficients of the model. With the consideration that the server refresh timer (e.g., 3 minutes) be typically faster than the UE request timer (e.g., 1 hour).

\For example, I&D servers 280 can monitor and measure a degree and/or rate of change associated with ionosphere coefficients and/or spherical harmonic expansion models. When the degree and/or rate of change exceed a variance threshold, I&D servers 280 can decrease the refresh timer to produce ionosphere coefficient files more often. Doing so can help ensure that UEs 210 are better able to correct errors in satellite signaling and shorter validity times of ionosphere coefficients and/or spherical harmonic expansion models resulting from the high rate or degree of change. By contrast, when the degree and/or rate of change is below a variance threshold (which can be a different threshold than the one above) I&D servers 280 can increase the refresh timer to be more in line with ionosphere coefficients and/or spherical harmonic expansion models having longer validity times. Any one or combination of the foregoing factors, triggers, or conditions can be applied to any example or implementation described herein.

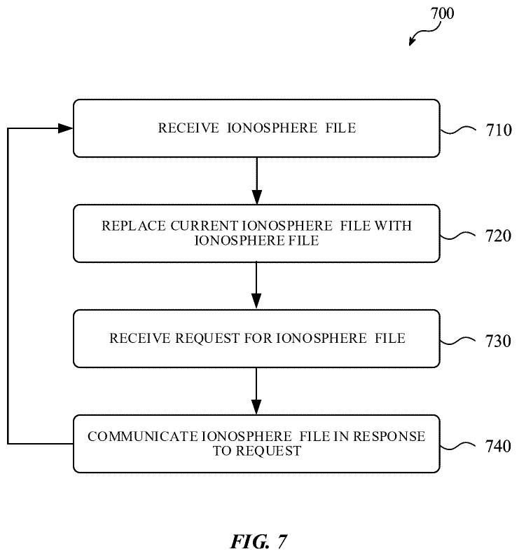

FIG. 7 is a diagram of an example of a process 700 for distributing an ionosphere file according to one or more implementations described herein. As shown, process 700 can be implemented by CDN servers 290. In some implementations, some or all of process 700 can be performed by one or more other systems or devices, including one or more of the devices of FIG. 2. Additionally, process 700 can include one or more fewer, additional, differently ordered and/or arranged operations than those shown in FIG. 7. In some implementations, some or all of the operations of process 700 can be performed independently, successively, simultaneously, etc., of one or more of the other operations of process 700. As such, the techniques described herein are not limited to the number, sequence, arrangement, timing, etc., of the operations or processes depicted in FIG. 7.

As shown, process 700 can include receiving an ionosphere file (block 710). For example, CDN servers 290 can receive an updated or real-time ionosphere file from I&D servers 280 according to a refresh timer. The refresh timer can be initiated and monitored by I&D servers 280 and/or CDN servers 290. Process 700 can include replacing a current ionosphere file with the ionosphere file (block 720). For example, CDN servers 290 can replace a previous or current ionosphere file with a new or updated ionosphere file recently received from I&D servers 290. In some implementations, CDN servers 290 can store the current and new ionosphere file, in addition to one or more ionosphere files preceding both the current and new ionosphere files.

Process 700 can include receiving a request for the ionosphere file (block 730). For example, CDN 290 can receive a request from UE 210 for the ionosphere file (e.g., the most recent or most current ionosphere file). In some implementations, the request can be for an assistance file for enhanced GPS or another type of location, positioning, tracking, or navigating service or capability.

Process 700 can include communicating an ionosphere file in response to the request (block 740). For example, CDN 290 can respond to a request for an ionosphere file by sending a most recent or newest ionosphere file to the requesting device (e.g., UE 210). In some implementations, CDN 290 can monitor a validity time of the ionosphere file, which can be based on a validity time of ionosphere coefficients and/or a spherical harmonic expansion model, corresponding to the ionosphere file. CDN 290 can determine or verify whether the request is received prior to an expiration of the validity time. When the ionosphere file is still valid, CDN 290 can respond to the request by sending the ionosphere file. When the ionosphere file is no longer valid, CDN 290 can wait for an updated ionosphere file from I&D servers 280 and respond to the request by sending the updated ionosphere file. In some implementations, CDN 290 can determine that an ionosphere file is no longer valid unless the ionosphere file will continue to be valid for at least a threshold period of time that is less than the validity time. In some implementations, CDN 290 can dynamically modify or update the threshold period of time based on a variance of ionosphere coefficients, a variance of spherical harmonic expansion models, and/or one or more other factors relating to an increased or decreased validity time. As shown, process 700 can return to receiving an ionosphere file (e.g., from I&D servers 280) (block 710).

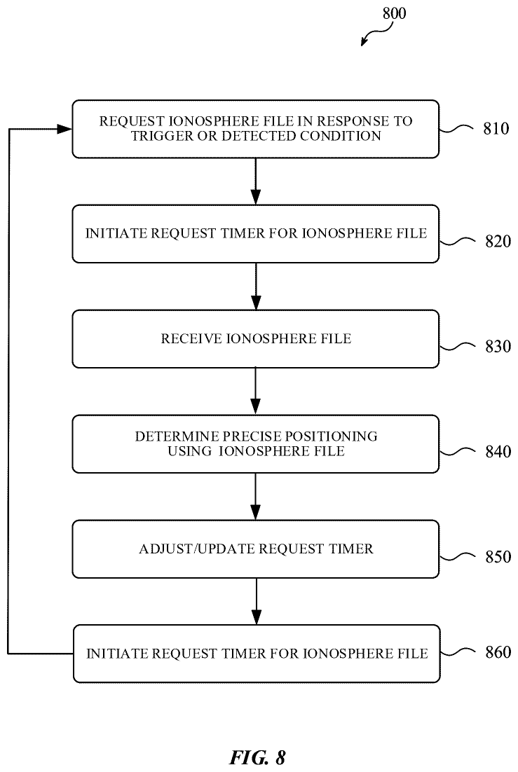

FIG. 8 is a diagram of an example of a process 800 for obtaining an ionosphere file according to one or more implementations described herein. As shown, process 800 can be implemented by UE 210 and/or baseband circuitry. In some implementations, some or all of process 800 can be performed by one or more other systems or devices, including one or more of the devices of FIG. 2. Additionally, process 800 can include one or more fewer, additional, differently ordered, and/or arranged operations than those shown in FIG. 8. In some implementations, some or all of the operations of process 800 can be performed independently, successively, simultaneously, etc., of one or more of the other operations of process 800. As such, the techniques described herein are not limited to the number, sequence, arrangement, timing, etc., of the operations or processes depicted in FIG. 8.

As shown, process 800 can include communicating a request for an ionosphere file in response to detecting at least one trigger associated with obtaining ionospheric information (block 810). For example, UE 210 can generate and transmit a request for an ionosphere file in response to detecting a corresponding trigger or condition. Examples of a trigger or condition can include detecting the expiration of a request timer. The request time can be an amount of time or periodicity with which UE 210 is to request updated ionosphere information that can better enable UE 210 to correct signaling errors or otherwise communicate with one or more satellites. UE 210 can initiate, modify, or resend a request timer in response to one or more factors, triggers, or conditions, such upon a new ionosphere file, upon exiting or entering an IDLE mode, ACTIVE mode, or another mode of operation. In another example, UE 210 can be configured to monitor a rate of success (and/or a degree of positioning precision) in using a current ionosphere file to correct satellite signaling errors, and in response to determining that the rate of success or degree of precision is below a corresponding threshold, UE 210 can request a new or more current ionosphere file from CDN servers 290.

Additional, or alternative, examples of factors, trigger, or conditions for requesting an ionosphere file can include UE 210 initiating an application that involves, or is configured for, highly precise geo-location, positioning, navigation, etc. In some implementations, UE 210 can send the request in response to initiating an application, or upon accessing a feature of the application or executing an operation or a set of instructions of an application. The trigger or condition can relate exclusively or inclusively to satellite communications. Exclusive communications can include transmitting and/or receive signals exclusive to satellites. Inclusive communications can include transmitting and/or receive signals from different types of wireless devices, including satellites. In some implementations, the satellite communications can involve a type of satellite, a type of satellite system or network, and/or a satellite of a particular altitude or orbit, such as a HEO satellite or satellite system. Any one or combination of the foregoing factors, triggers, or conditions can be applied to any example or implementation described herein.

Process 800 can include initiating a request timer for an ionosphere file. (block 820). For example, UE can initiate a request timer in response to sending a request to CDN 290 for an ionosphere file. The request can include a request for an enhanced GPS file or another type of data structure with information to enable UE 210 to perform enhanced GPS procedures. The request timer can been greater than a refresh timer of I&D servers 280 and less than a validity time of a VTEC spherical harmonic expansion model or ionosphere coefficients of a VTEC spherical harmonic expansion model. In some implementations, the request timer can have a configured default value, which can be a simple value (e.g., 1 hour). In some implementations, UE 210 can be configured to determine the request timer according to a schedule, prompt, or other event. UE 210 can determine the request timer in accordance with an evaluation or determination procedure, such as determining the request timer as a percentage or ratio of the refresh timer, validity time, or a combination thereof.

Process 800 can include receiving the ionosphere file (block 830). For example, UE 210 can receive an ionosphere file in response to sending a request for the ionosphere file to CDN servers 290. The ionosphere file can include ionosphere coefficients for correcting errors pertaining to satellite signals due to ionospheric conditions. The ionosphere coefficients can be part of a VTEC spherical harmonic expansion model representing a current state or condition of the ionosphere or portions of the ionosphere.

Portions of the ionosphere can refer to different layers of the ionosphere or portions of the ionosphere that correspond to different geographic areas of the Earth (e.g., a geographic area where UE 210 is located). In some implementations, CDN servers 290 can have different ionosphere files (e.g., each file can have a different set or group of ionosphere coefficients) and different UEs 210 can receive an ionosphere file based on one or more factors or conditions, such as UE capabilities, UE location, a priority associated with UE 210, degree or level of PPP accuracy associated with UE 210 or requested by UE 210, etc. For example, different applications executed or initiated by UE 210 can cause UE 210 send a particular type of a request or a request for a particular type of ionosphere conditions information. A regional ionosphere service, for example, can be provided, which can increase precision per geographic location, area, region, etc., using the same or a different number of coefficients of the ionosphere file. In such scenarios, the coefficients can be used to describe a geographic location, area, region, etc., instead of the whole globe. The bit stream for the globe can be provided (e.g., dumped) in I&D servers 280, and I&D servers 280 can process the data according to datasets or ionosphere files associated with different geographic locations, areas, regions, etc. I&D servers 280 (and/or one or more other server devices) can cause or ensure that the datasets are distribute to UEs 210 accordingly.

The ionosphere file can be (or be part of) a GPS assistance file for more precise positioning and navigation services and capabilities. The ionosphere file can be a non-mandatory file for UE 210. For example, UE 210 can be capable of positioning and navigation services without the ionosphere file; however, having the ionosphere file can enable UE 210 to provide superior or more precise and accurate positioning and navigation services. An ionosphere file, as referred to herein, can include an ionosphere coefficients file.

The ionosphere file can be distributed using the same channels as other files that sent or distributed to UEs 210 of a certain group, type, make, model, service subscription, carrier registration, etc. The ionosphere file can also, or alternatively, be distributed to UEs 210 based on one or more factors or conditions, such as UEs 210 having a particular capability, set of capabilities, state of operation, threshold of available resources, threshold amount of battery power, etc. The ionosphere file can be distributed through a CDN, which can include CDN servers 290. The ionosphere file can be distributed in response to a URL HTTP request from UE 210 to CDN servers 290.

Providing the ionosphere file upon request (as opposed to via push operation) can enable UEs 210 to request specific files on-demand or otherwise based on need (e.g., UE 210 running an application that involves geo-location, position, navigation, etc.). As such, when UE 210 requests a high-accuracy GPS position in response to initiating a mapping or navigation application, UE 210 can download the file that enables greater location precision. By contrast, when UE 210 initiates an application that does not involve highly accurate positioning, such as a weather application, UE 210 can conserve processing, memory, transmission and reception resources, and battery power by foregoing a request for the ionosphere file.

Process 800 can include receiving the ionosphere file (block 830). For example, UE 210 can receive an ionosphere file from CDN servers 290. The ionosphere file can be received in repones to UE 210 sending a request for the ionosphere file to CDN servers 290. In some implementations, process 800 can include initiating a request timer (block 820) in response to receiving the ionosphere file.

Process 800 can include determining precise positioning based on the ionosphere file (block 840). For example, UE 210 can use the ionosphere file to correct errors in signals between UE 210 and one or more satellites 260. UE 210 can use one or more of the ionosphere coefficients of the ionosphere file to determine the atmospheric delays that impact the ray paths of the GPS signals that arrive to the UE for range computations (a typical step in GPS position estimation). The ionosphere coefficients are used to model the ionosphere VTEC to compensate for these atmospheric delays that affect the GPS signals from the satellites to the UE (downlink). In some implementations, UE 210 can use the ionosphere file in one or more additional or alternative ways to correct errors or otherwise improve communications between UE 210 and one or more satellites 260. In some implementations, UE 210 can correct errors in downlink signaling.

Process 800 can include dynamically adapting or modifying the request timer (block 850). For example, UE 210 can dynamically adapt or modify the request timer in response to one or more factors, triggers, or conditions. This can include UE 210 increasing or decreasing the request timer in repones to the detected factor, trigger, or condition. Examples of such factors, triggers, or conditions can include a rate of successfully correcting signaling errors falls below a failure threshold or falls to exceed a success threshold, in which case the request timer can be decreased. In some implementations, he request timer can instead be decreased in response to a change in the rate of successful or successful error corrections.

Additional examples can include a signal quality, throughput, or other characteristic of a channel or signal fall below or exceeding a corresponding threshold. In another example, UE 210 can increase or decrease the request rate based on preferences or requirements of a particular application or a threshold number of applications being executed by UE 210. In another example, UE 210 can increase or decrease the request rate based on an availably of local resources (e.g., memory, processing capacity, battery power, etc.), an amount or rate of data flow in an uplink and/or downlink direction, a level of priority associated with an application involving precise positioning relative to a priority of one or more other applications or functions being executed by UE 210, whether UE 210 is in an active mode, idle mode, a rate of change between active and idle mode, a predicted change between active and idle modes, and more.

In another example, UE 210 can monitor a validity time of a current ionosphere file (and/or one or more previous ionosphere files) and can increase or decrease the request rate based on a validity time, pattern of validity times, or trend of validity times exhibited by one or more ionosphere files. As a validity time of ionosphere files appears to be decreasing (e.g., because of an increase in a degree and/or rate of change in ionosphere conditions), UE 210 can increase the request rate. By contrast, as a validity time of ionosphere files appears to be increasing (e.g., because of a decrease in a degree and/or rate of change in ionosphere conditions), UE 210 can decrease the request rate to save local resources, battery power, network resources, bandwidth, etc. Any one or combination of the foregoing factors, triggers, or conditions can be applied to any example or implementation described herein.

Process 800 can include initiating the request timer (block 860). For example, UE 210 can initiate or reinitiate the request timer in response to adjusting or updating an ongoing request timer. UE 210 can also, or alternatively, initiate the request timer in response to one or more other factors, triggers, or conditions, such as the completion of a precise geo-location, positioning, or navigation procedure. UE 210 can also, or alternatively, initiate the request timer in response to receiving an ionosphere file instead of, for example, doing so in response to sending a request for an ionosphere file. Any one or combination of the foregoing factors, triggers, or conditions, or other factors, triggers, or conditions, can be configured to cause UE 210 to initiate a request timer. Additional examples are discussed above (block 820).

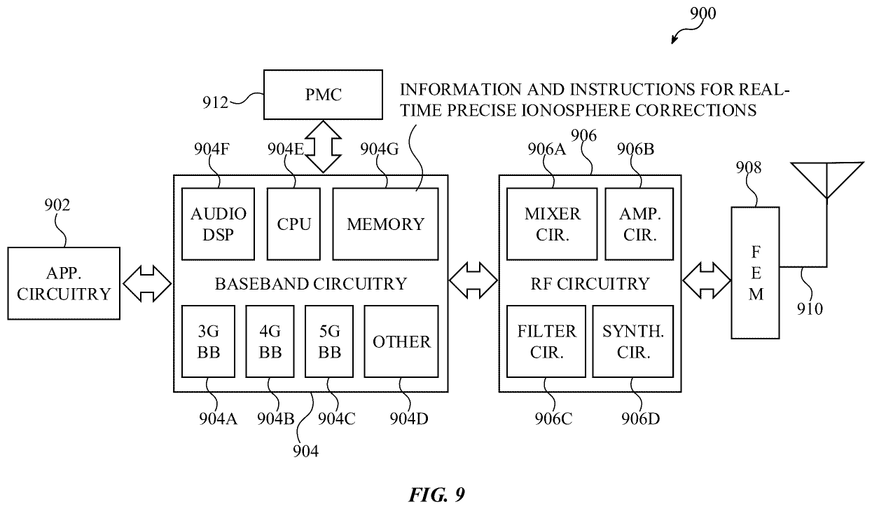

FIG. 9 is a diagram of an example of components of a device according to one or more implementations described herein. In some implementations, device 900 can include application circuitry 902, baseband circuitry 904, RF circuitry 906, front-end module (FEM) circuitry 908, one or more antennas 910, and power management circuitry (PMC) 912 coupled together at least as shown. In some implementations, device 900 can include fewer elements (e.g., a RAN node may not utilize application circuitry 902 and can instead include a processor/controller to process data received from a core network. In some implementations, device 900 can include additional elements such as, for example, memory/storage, display, camera, sensor (including one or more temperature sensors, such as a single temperature sensor, a plurality of temperature sensors at different locations in device 900, etc.), or input/output (I/O) interface. In other implementations, the components described below can be included in more than one device (e.g., said circuitries can be separately included in more than one device for cloud-RAN (C-RAN) implementations).

Application circuitry 902 can include one or more application processors. For example, application circuitry 902 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on device 900. In some implementations, processors of application circuitry 902 can process data packets received from a core network.

Baseband circuitry 904 can include circuitry such as, but not limited to, one or more single-core or multi-core processors. Baseband circuitry 904 can include one or more baseband processors or control logic to process baseband signals received from a receive signal path of RF circuitry 906 and to generate baseband signals for a transmit signal path of RF circuitry 906. Baseband circuity 904 can interface with application circuitry 902 for generation and processing of the baseband signals and for controlling operations of RF circuitry 906. For example, in some implementations, baseband circuitry 904 can include a 3G baseband processor 904A, a 4G baseband processor 904B, a 5G baseband processor 904C, or other baseband processor(s) 904D for other existing generations, generations in development or to be developed in the future (e.g., 5G, 6G, 7G, etc.). Baseband circuitry 904 (e.g., one or more of baseband processors 904A-D) can handle various radio control functions that enable communication with one or more radio networks via RF circuitry 906. In other implementations, some or all of the functionality of baseband processors 904A-D can be included in modules stored in memory 904G and executed via a central processing unit (CPU) 904E. The radio control functions can include, but are not limited to, signal modulation/demodulation, encoding/decoding, radio frequency shifting, etc. In some implementations, modulation/demodulation circuitry of baseband circuitry 904 can include Fast-Fourier Transform (FFT), precoding, or constellation mapping/de-mapping functionality. In some implementations, encoding/decoding circuitry of baseband circuitry 904 can include convolution, tail-biting convolution, turbo, Viterbi, or low-density parity check (LDPC) encoder/decoder functionality. Implementations of modulation/demodulation and encoder/decoder functionality are not limited to these examples and can include other suitable functionality in other implementations.

In some implementations, memory 904G can receive and/or store information and instructions for I&D servers 280 can receive an NTRIP bit stream of a VTEC spherical harmonic expansion model for PPP. I&D servers 280 can generate an ionosphere file of ionosphere coefficients of the VTEC spherical harmonic expansion model, according to a refresh timer, and can send the ionosphere file to CDN servers 290 for distribution upon request. UEs 210 can be configured to request the ionosphere file according to a request timer. The duration of the request timer can be less than an amount of time for which the VTEC spherical harmonic expansion model is valid. Accordingly, due to the refresh timer and the request timer, UEs 210 can consistently receive current or real-time ionosphere coefficients of a VTEC spherical harmonic expansion model. These and many other features and examples are described herein.

In some implementations, baseband circuitry 904 can include one or more audio digital signal processor(s) (DSP) 904F. Audio DSP 904F can include elements for compression/decompression and echo cancellation and can include other suitable processing elements in other implementations. Components of baseband circuitry 904 can be suitably combined in a single chip, a single chipset, or disposed on a same circuit board in some implementations. In some implementations, some or all of the constituent components of baseband circuitry 904 and application circuitry 902 can be implemented together such as, for example, on a system on a chip (SOC).

In some implementations, baseband circuitry 904 can provide for communication compatible with one or more radio technologies. For example, in some implementations, baseband circuitry 904 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which baseband circuitry 904 is configured to support radio communications of more than one wireless protocol can be referred to as multi-mode baseband circuitry.

RF circuitry 906 can enable communication with wireless networks using modulated electromagnetic radiation through a non-solid medium. In various implementations, RF circuitry 906 can include switches, filters, amplifiers, etc., to facilitate the communication with the wireless network. RF circuitry 906 can include a receive signal path which can include circuitry to down-convert RF signals received from FEM circuitry 908 and provide baseband signals to baseband circuitry 904. RF circuitry 906 can also include a transmit signal path which can include circuitry to up-convert baseband signals provided by baseband circuitry 904 and provide RF output signals to FEM circuitry 908 for transmission.

In some implementations, the receive signal path of RF circuitry 906 can include mixer circuitry 906A, amplifier circuitry 906B and filter circuitry 906C. In some implementations, the transmit signal path of RF circuitry 906 can include filter circuitry 906C and mixer circuitry 906A. RF circuitry 906 can also include synthesizer circuitry 906D for synthesizing a frequency for use by mixer circuitry 906A of the receive signal path and the transmit signal path. In some implementations, mixer circuitry 906A of the receive signal path can be configured to down-convert RF signals received from FEM circuitry 908 based on the synthesized frequency provided by synthesizer circuitry 906D. Amplifier circuitry 906B can be configured to amplify the down-converted signals and filter circuitry 906C can be a low-pass filter (LPF) or band-pass filter (BPF) configured to remove unwanted signals from the down-converted signals to generate output baseband signals. Output baseband signals can be provided to baseband circuitry 904 for further processing. In some implementations, the output baseband signals can be zero-frequency baseband signals, although this may not be a requirement. In some implementations, mixer circuitry 906A of the receive signal path can comprise passive mixers, although the scope of the implementations is not limited in this respect.

In some implementations, mixer circuitry 906A of the transmit signal path can be configured to up-convert input baseband signals based on the synthesized frequency provided by synthesizer circuitry 906D to generate RF output signals for FEM circuitry 908. The baseband signals can be provided by baseband circuitry 904 and can be filtered by filter circuitry 906C. In some implementations, mixer circuitry 906A of the receive signal path and mixer circuitry 906A of the transmit signal path can include two or more mixers and can be arranged for quadrature down conversion and up conversion, respectively. In some implementations, mixer circuitry 906A of the receive signal path and mixer circuitry 906A of the transmit signal path can include two or more mixers and can be arranged for image rejection. In some implementations, mixer circuitry 906A of the receive signal path and mixer circuitry 906A can be arranged for direct down conversion and direct up conversion, respectively. In some implementations, mixer circuitry 906 of the receive signal path and mixer circuitry 906A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, RF circuitry 906 can include analog-to-digital converter (ADC) and digital-to-analog converter (DAC) circuitry and baseband circuitry 904 can include a digital baseband interface to communicate with RF circuitry 906.

In some dual-mode implementations, a separate radio integrated circuitry can be provided for processing signals for each spectrum, although the scope of the implementations is not limited in this respect. In some implementations, synthesizer circuitry 906D can be a fractional-N synthesizer or a fractional N/N+1 synthesizer, although the scope of the implementations is not limited in this respect as other types of frequency synthesizers can be suitable. For example, synthesizer circuitry 906D can be a delta-sigma synthesizer, a frequency multiplier, or a synthesizer comprising a phase-locked loop with a frequency divider.

Synthesizer circuitry 906D can be configured to synthesize an output frequency for use by mixer circuitry 906A of RF circuitry 906 based on a frequency input and a divider control input. In some implementations, synthesizer circuitry 906D can be a fractional N/N+1 synthesizer. In some implementations, frequency input can be provided by a voltage-controlled oscillator (VCO). Divider control input can be provided by either baseband circuitry 904 or the applications circuitry 902 depending on the desired output frequency. In some implementations, a divider control input (e.g., N) can be determined from a look-up table based on a channel indicated by the applications circuitry 902.

Synthesizer circuitry 906D of RF circuitry 906 can include a divider, a delay-locked loop (DLL), a multiplexer, and a phase accumulator. In some implementations, the divider can be a dual modulus divider (DMD), and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 906D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, RF circuitry 906 can include an in-phase/quadrature (I/Q)/polar converter.

FEM circuitry 908 can include a receive signal path which can include circuitry configured to operate on RF signals received from one or more antennas 910, amplify the received signals and provide the amplified versions of the received signals to RF circuitry 906 for further processing. FEM circuitry 908 can also include a transmit signal path which can include circuitry configured to amplify signals for transmission provided by RF circuitry 906 for transmission by one or more of the one or more antennas 910. In various implementations, the amplification through the transmit or receive signal paths can be done solely in RF circuitry 906, solely in FEM circuitry 908, or in both RF circuitry 906 and FEM circuitry 908.

In some implementations, FEM circuitry 908 can include a transmit/receive switch to switch between transmit mode and receive mode operation. FEM circuitry 908 can include a receive signal path and a transmit signal path. The receive signal path of FEM circuitry 908 can include a low noise amplifier to amplify received RF signals and provide the amplified received RF signals as an output (e.g., to RF circuitry 906). The transmit signal path of FEM circuitry 908 can include a power amplifier to amplify input RF signals (e.g., provided by RF circuitry 906), and one or more filters to generate RF signals for subsequent transmission (e.g., by one or more of one or more antennas 910).

In some implementations, PMC 912 can manage power provided to baseband circuitry 904. In particular, PMC 912 can control power-source selection, voltage scaling, battery charging, or direct current (DC) to DC (DC-to-DC) conversion. PMC 912 can often be included when device 900 is capable of being powered by a battery, for example, when device 900 is included in a UE. PMC 912 can increase the power conversion efficiency while providing desirable implementation size and heat dissipation characteristics.

While FIG. 9 shows PMC 912 coupled only with baseband circuitry 904. However, in other implementations, PMC 912 can be additionally or alternatively coupled with, and perform similar power management operations for, other components such as, but not limited to, application circuitry 902, RF circuitry 906, or FEM circuitry 908.

In some implementations, PMC 912 can control, or otherwise be part of, various power saving mechanisms of device 900. For example, if device 900 is in an RRC_Connected state, where device 900 is still connected to the RAN node as device 900 expects to receive traffic shortly, then device 900 can enter a state known as discontinuous reception mode (DRX) after a period of inactivity. During this state, device 900 can power down for brief intervals of time and thus save power.

If there is no data traffic activity for an extended period of time, then device 900 can transition off to an RRC_Idle state, where device 900 disconnects from the network and does not perform operations such as channel quality feedback, handover, etc. Device 900 can go into a very low power state and device 900 can perform paging where again device 900 periodically can wake up to listen to the network and then power down again. Device 900 may not receive data in this state; in order to receive data, device 900 can transition back to RRC_Connected state.

An additional power saving mode can allow a device to be unavailable to the network for periods longer than a paging interval (ranging from seconds to a few hours). During this time, the device 900 can be unreachable to the network and can power down completely. Any data sent during this time can incur a large delay and device 900 can assume the delay is acceptable.

Processors of application circuitry 902 and processors of baseband circuitry 904 can be used to execute elements of one or more instances of a protocol stack. For example, processors of baseband circuitry 904, alone or in combination, can be used execute Layer 3, Layer 2, or Layer 1 functionality, while processors of baseband circuitry 904 can utilize data (e.g., packet data) received from these layers and further execute Layer 4 functionality (e.g., transmission communication protocol (TCP) and user datagram protocol (UDP) layers). As referred to herein, Layer 3 can comprise a radio resource control layer. As referred to herein, Layer 2 can comprise a medium access control layer, a radio link control layer, and a packet data convergence protocol layer, described in further detail below. As referred to herein, Layer 1 can comprise a physical layer of a UE/RAN node.

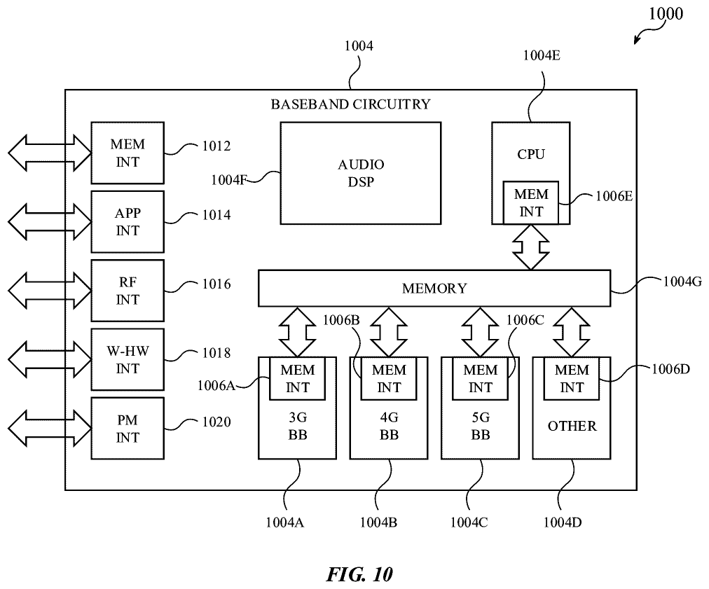

FIG. 10 is a diagram of example interfaces 1000 of baseband circuitry according to one or more implementations described herein. One or more components or features of example interfaces 1000 can correspond to one or more components or features described above or elsewhere. Baseband circuitry 1004 can comprise processors 1004A, 1004B, 1004C, 1004D, and 1004E and a memory 1004G utilized by said processors. Each of processors 1004A, 1004B, 1004C, 1004D, and 1004E can include a memory interface, 1006A, 1006B, 1006C, 1006D, and 1006E, respectively, to send/receive data to/from memory 1004G. Baseband circuitry can be a component of a UE and/or another type of device or system capable of transmitting and/or receiving wireless signals.

Baseband circuitry 1004 can further include one or more interfaces to communicatively couple to other circuitries/devices, such as memory interface 1012 (e.g., an interface to send/receive data to/from memory external to baseband circuitry 1004), an application circuitry interface 1014 (e.g., an interface to send/receive data to/from the application circuitry as described herein), an RF circuitry interface 1016, a wireless hardware connectivity interface 1018 (e.g., an interface to send/receive data to/from near field communication components, Bluetooth® components (e.g., Bluetooth® Low Energy), Wi-Fi® components, and other communication components), and a power management interface 1020 (e.g., an interface to send/receive power or control signals to/from a PMC).

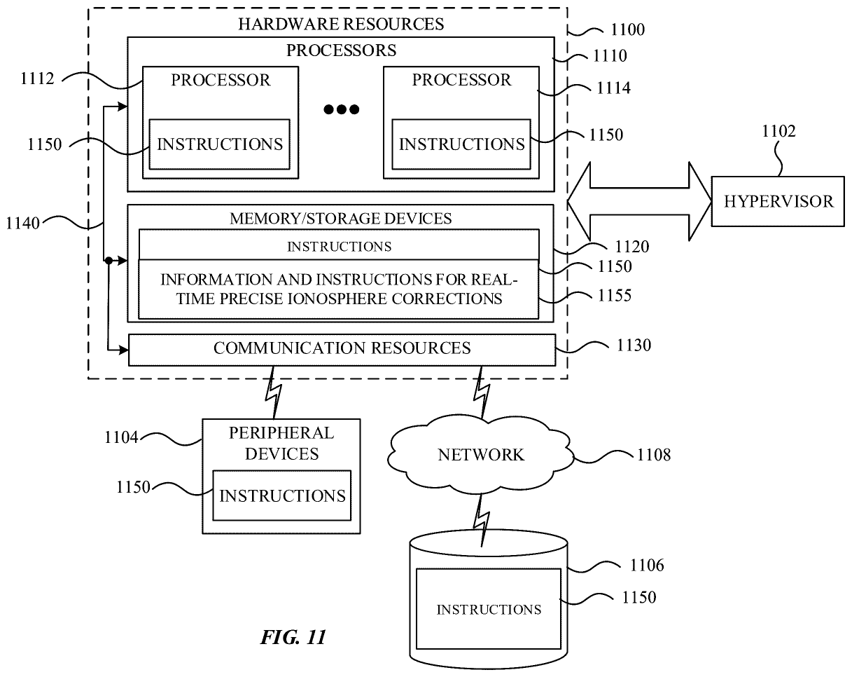

FIG. 11 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 11 shows a diagrammatic representation of hardware resources 1100 including one or more processors 1110 (or processor cores), one or more memory/storage devices 1120, and one or more communication resources 1130, each of which can be communicatively coupled via a bus 1140. For implementations where node virtualization or network function virtualization is utilized, a hypervisor can be executed to provide an execution environment for one or more network slices/sub-slices to utilize hardware resources 1100. Hardware resources 1100 can interact with hypervisor 1102. For example, hypervisor 1102 can schedule or otherwise manage hardware resource 1100.

Processors 1110 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) can include, for example, a processor 1112 and a processor 1114.

Memory/storage devices 1120 can include main memory, disk storage, or any suitable combination thereof. Memory/storage devices 1120 can include, but are not limited to any type of volatile or non-volatile memory such as dynamic random-access memory (DRAM), static random-access memory (SRAM), erasable programmable read-only memory (EPROM), electrically erasable programmable read-only memory (EEPROM), flash memory, solid-state storage, etc.

In some implementations, memory/storage devices 1120 receive and/or store information and instructions 1155 for I&D servers 280 can receive an NTRIP bit stream of a VTEC spherical harmonic expansion model for PPP. I&D servers 280 can generate an ionosphere file of ionosphere coefficients of the VTEC spherical harmonic expansion model, according to a refresh timer, and can send the ionosphere file to CDN servers 290 for distribution upon request. UEs 210 can be configured to request the ionosphere file according to a request timer. The duration of the request timer can be less than the amount of time for which the VTEC spherical harmonic expansion model is valid. Accordingly, due to the refresh timer and the request timer, UEs 210 can consistently receive current or real-time ionosphere coefficients of a VTEC spherical harmonic expansion model. These and many other features and examples are described herein.

Communication resources 1130 can include interconnection or network interface components or other suitable devices to communicate with one or more peripheral devices 1104 or one or more databases 1106 via a network 1108. For example, communication resources 1130 can include wired communication components (e.g., for coupling via a universal serial bus), cellular communication components, near field communication components, Bluetooth® components (e.g., Bluetooth® Low Energy), Wi-Fi® components, and other communication components.

Instructions 1150A, 1150B, 1150C, 1150D, and/or 1150E can comprise software, a program, an application, an applet, an app, or other executable code for causing at least any of processors 1110 to perform any one or more of the methodologies discussed herein. Instructions 1150 can reside, completely or partially, within at least one of processors 1110 (e.g., within a cache memory), memory/storage devices 1120, or any suitable combination thereof. Furthermore, any portion of instructions 1150A-E can be transferred to hardware resources 1100 from any combination of peripheral devices 1104 or databases 1106. Accordingly, memory of processors 1110, memory/storage devices 1120, peripheral devices 1104, and databases 1106 are examples of computer-readable and machine-readable media.

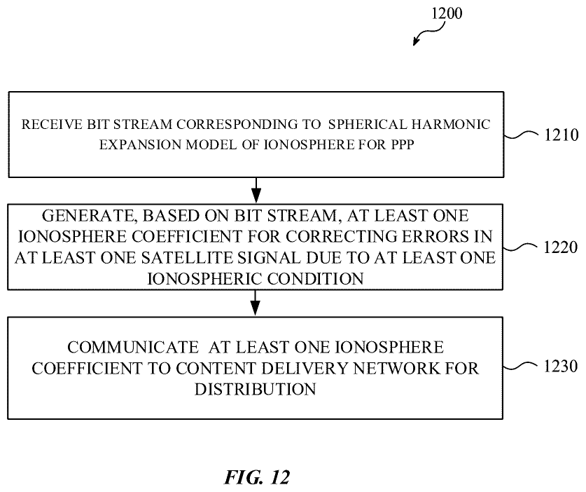

FIG. 12 is a diagram of an example process 1200 for real-time precise ionosphere corrections according to one or more implementations described herein. As shown, process 1200 can be implemented by I&D server 280. In some implementations, some or all of process 1200 can be performed by one or more other systems or devices, including one or more of the devices of FIG. 2. Additionally, process 1200 can include one or more fewer, additional, differently ordered and/or arranged operations than those shown in FIG. 12. In some implementations, some or all of the operations of process 1200 can be performed independently, successively, simultaneously, etc., of one or more of the other operations of process 1200. As such, the techniques described herein are not limited to the number, sequence, arrangement, timing, etc., of the operations or processes depicted in FIG. 12.

As shown, process 1200 can include receiving a bit stream corresponding to a spherical harmonic expansion model of an ionosphere for precise point positioning (PPP) (block 1210). For example, I&D server 280 can receive the bit stream until a full set of coefficients are received. I&D server 280 can timestamp the received data in response to receiving the full set of coefficients. I&D server 280 can use the timestamp to determine when to generate a corresponding ionosphere file according to a refresh timer measured from the timestamp.

Process 1200 can include generating, based on the bit stream, at least one ionosphere coefficient for correcting at least one error in at least one satellite signal due to at least one ionospheric condition (block 1220). Process 1200 can include communicating the at least one ionosphere coefficient to a content delivery network for distribution (block 1230). One or more of the examples described herein can also, or alternatively be part of process 1200.

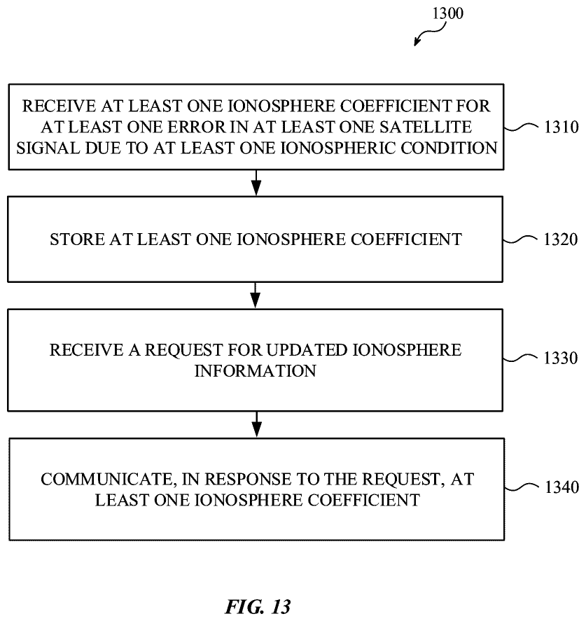

FIG. 13 is a diagram of an example process 1300 for real-time precise ionosphere corrections according to one or more implementations described herein. As shown, process 1300 can be implemented by CDN server 290. In some implementations, some or all of process 1300 can be performed by one or more other systems or devices, including one or more of the devices of FIG. 2. Additionally, process 1300 can include one or more fewer, additional, differently ordered, and/or arranged operations than those shown in FIG. 13. In some implementations, some or all of the operations of process 1300 can be performed independently, successively, simultaneously, etc., of one or more of the other operations of process 1300. As such, the techniques described herein are not limited to the number, sequence, arrangement, timing, etc., of the operations or processes depicted in FIG. 13.

As shown, process 1300 can include receiving at least one ionosphere coefficient for at least one error in at least one satellite signal due to at least one ionospheric condition (block 1310). Process 1300 can include storing the at least one ionosphere coefficient (block 1320). Process 1300 can also include receiving a request for updated ionosphere information (block 1330). Process 1300 can further include, in response to the request, the at least one ionosphere coefficient (block 1340). One or more of the examples described herein can also, or alternatively be part of process 1300.

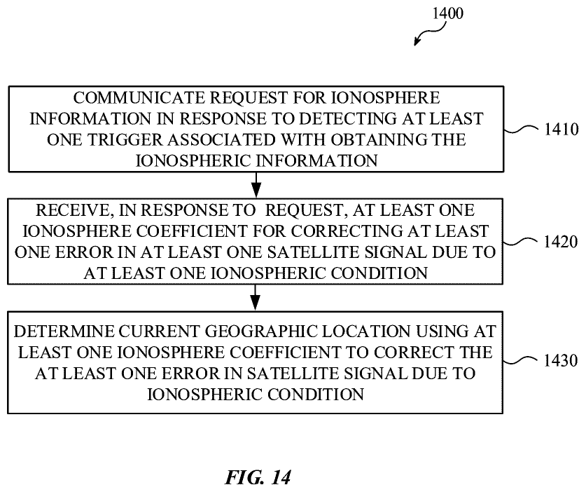

FIG. 14 is a diagram of an example process 1400 for real-time precise ionosphere corrections according to one or more implementations described herein. As shown, process 1400 can be implemented by UE 210 and/or baseband circuitry. In some implementations, some or all of process 1400 can be performed by one or more other systems or devices, including one or more of the devices of FIG. 2. Additionally, process 1400 can include one or more fewer, additional, differently ordered, and/or arranged operations than those shown in FIG. 14. In some implementations, some or all of the operations of process 1400 can be performed independently, successively, simultaneously, etc., of one or more of the other operations of process 1400. As such, the techniques described herein are not limited to the number, sequence, arrangement, timing, etc., of the operations or processes depicted in FIG. 14. One or more of the examples described herein can also, or alternatively be part of process 1400.

As shown, process 1400 can include communicating a request for ionosphere information in response to detecting at least one trigger associated with obtaining the ionospheric information (block 1410). Process 1400 can include receiving, in response to the request, at least one ionosphere coefficient for correcting at least one error in at least one satellite signal due to at least one ionospheric condition (block 1420). Process 1400 can include determining a current geographic location by using the at least one ionosphere coefficient to correct the at least one error in the at least one satellite signal due to the at least one ionospheric condition (block 1430). One or more of the examples described herein can also, or alternatively be part of process 1400.

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which can also include one or more of the examples described herein, a server device comprising: one or more processors configured to: receive a bit stream corresponding to a spherical harmonic expansion model of an ionosphere for precise point positioning (PPP); generate, based on the bit stream, at least one ionosphere coefficient for correcting at least one error in at least one satellite signal due to at least one ionospheric condition; and communicate the at least one ionosphere coefficient to a content delivery network for distribution.

In example 2, which can also include one or more of the examples described herein, the one or more processors are further configured to: detect an expiration of a refresh timer; encode, in response to expiration of the refresh timer, the bit stream to create an encoded bit stream; and pack the encoded bit stream to generate an ionosphere file comprising the at least one ionosphere coefficient.

In example 3, which can also include one or more of the examples described herein, the ionosphere file is a compressed file.

In example 4, which can also include one or more of the examples described herein, the one or more processors are further configured to: communicate the ionosphere file to the content delivery network; and initiate the refresh timer in response to communicating the ionosphere file.

In example 5, which can also include one or more of the examples described herein, the one or more processors are further configured to: receive, prior to expiration of the refresh timer, an additional bit stream corresponding to an additional spherical harmonic expansion model.

In example 6, which can also include one or more of the examples described herein, the bit stream comprises a Networked Transport of Radio Technical Commission For Maritime Services (RTCM) via Internet Protocol (NTRIP) bit stream.

In example 7, which can also include one or more of the examples described herein, the bit stream is received from a PPP server.

In example 8, which can also include one or more of the examples described herein, the at least one ionosphere coefficient is derived from the at least one measurement of ionosphere conditions.

In example 9, which can also include one or more of the examples described herein, the spherical harmonic expansion model comprises a vertical total electron content (VTEC) spherical harmonic expansion model.

In example 10, which can also include one or more of the examples described herein, the spherical harmonic expansion model is associated with a validity time that comprises an amount of time for which the at least one ionosphere coefficient can be used to correct for the at least one error in the at least one satellite signal.

In example 11, which can also include one or more of the examples described herein, the ionosphere file is distributed to user equipment (UE) according to a request timer.

In example 12, which can also include one or more of the examples described herein, the one or more processors are further configured to: the request timer is greater than a refresh timer, the refresh timer comprising a duration of time between generating the at least one ionosphere coefficient and generating another ionosphere coefficient to update the at least one ionosphere coefficient; and the request timer is less than the validity time.

In example 13, which can also include one or more of the examples described herein, the one or more processors are further configured to: the request timer is 1 hour or less; the refresh timer is 3 minutes or less; and the validity time is 2 hours.

In example 14, which can also include one or more of the examples described herein, a server device comprising: one or more processors configured to: receive at least one ionosphere coefficient for at least one error in at least one satellite signal due to at least one ionospheric condition; store the at least one ionosphere coefficient; receive a request for updated ionosphere information; and communicate, in response to the request, the at least one ionosphere coefficient.

In example 15, which can also include one or more of the examples described herein, the at least one ionosphere coefficient is associated with a validity time that comprises an amount of time for which the at least one ionosphere coefficient effective for correcting for the at least one error in the at least one satellite signal.

In example 16, which can also include one or more of the examples described herein, the at least one ionosphere coefficient corresponds to a vertical total electron content (VTEC) spherical harmonic expansion model.

In example 17, which can also include one or more of the examples described herein, the request is received according to a request timer, the request timer is greater than a refresh timer, the refresh timer comprising a duration of time between generating the at least one ionosphere coefficient and generating another ionosphere coefficient to update the at least one ionosphere coefficient and the request timer is less than the validity time.

In example 18, which can also include one or more of the examples described herein, the one or more processors are further configured to: replace a current ionosphere coefficient with the at least one ionosphere coefficient.

In example 19, which can also include one or more of the examples described herein, a user equipment (UE) can comprise: one or more processors configured to: communicate a request for ionosphere information in response to detecting at least one trigger associated with obtaining the ionospheric information; receive, in response to the request, at least one ionosphere coefficient for correcting at least one error in at least one satellite signal due to at least one ionospheric condition; and determine a current geographic location by using the at least one ionosphere coefficient to correct the at least one error in the at least one satellite signal due to the at least one ionospheric condition.

In example 20, which can also include one or more of the examples described herein, the one or more processors are further configured to: initiate a request timer for requesting updated ionosphere information.

In example 21, which can also include one or more of the examples described herein, the one or more processors are further configured to: request, in response to expiration of the request timer, the updated ionosphere information.

In example 22, which can also include one or more of the examples described herein, the one or more processors are further configured to: the request timer is greater than a refresh timer associated with creation of the at least one ionosphere coefficient; and the request timer is less than a validity time associated with the at least one ionosphere coefficient for correcting the at least one error in the at least one satellite signal.

In example 23, which can also include one or more of the examples described herein, the at least one trigger comprises detecting an expiration of a request timer that comprises a duration of time for obtaining updated ionosphere information.

In example 24, which can also include one or more of the examples described herein, the at least one trigger comprises initiating an application associated with geo-positioning or navigation.

In example 25, which can also include one or more of the examples described herein, the current geographic location is determined using the PPP.

In example 26, which can also include one or more of the examples described herein, a method can comprise: receiving a bit stream corresponding to a spherical harmonic expansion model of an ionosphere for precise point positioning (PPP); generating, based on the bit stream, at least one ionosphere coefficient for correcting errors in at least one satellite signal due to at least one ionospheric condition; and communicating the ionosphere file to a content delivery network for distribution.

In example 27, which can also include one or more of the examples described herein, detecting an expiration of a refresh timer; encoding, in response to expiration of the refresh timer, the bit stream to create an encoded bit stream; and packing the encoded bit stream to generate an ionosphere file comprising the at least one ionosphere coefficient.

In example 28, which can also include one or more of the examples described herein, a method can comprise: receiving at least one ionosphere coefficient for at least one error in at least one satellite signal due to at least one ionospheric condition; storing the at least one ionosphere coefficient; receiving a request for updated ionosphere information; and communicating, in response to the request, the at least one ionosphere coefficient.

In example 29, which can also include one or more of the examples described herein, the at least one ionosphere coefficient is associated with a validity time that comprises an amount of time for which the at least one ionosphere coefficient effective for correcting for the at least one error in the at least one satellite signal.

In example 30, which can also include one or more of the examples described herein, a method can comprise: communicating a request for ionosphere information in response to detecting at least one trigger associated with obtaining the ionospheric information; receiving, in response to the request, at least one ionosphere coefficient for correcting at least one error in at least one satellite signal due to at least one ionospheric condition; and determining a current geographic location by using the at least one ionosphere coefficient to correct the at least one error in the at least one satellite signal due to the at least one ionospheric condition.

In example 31, which can also include one or more of the examples described herein, initiating a request timer for requesting updated ionosphere information.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature can have been disclosed with respect to only one of several implementations, such feature can be combined with one or more other features of the other implementations as can be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context can indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. A server device comprising:
one or more processors configured to:
receive a bit stream corresponding to a spherical harmonic expansion model of an ionosphere for precise point positioning (PPP);
generate, based on the bit stream, at least one ionosphere coefficient for correcting at least one error in at least one satellite signal due to at least one ionospheric condition; and
communicate the at least one ionosphere coefficient to a content delivery network for distribution.

2. The server device of claim 1, wherein the one or more processors are further configured to:
detect an expiration of a refresh timer;
encode, in response to expiration of the refresh timer, the bit stream to create an encoded bit stream; and
pack the encoded bit stream to generate an ionosphere file comprising the at least one ionosphere coefficient.

3. The server device of claim 2, wherein the ionosphere file is a compressed file.

4. The server device of claim 2, wherein the one or more processors are further configured to:
communicate the ionosphere file to the content delivery network; and
initiate the refresh timer in response to communicating the ionosphere file.

5. The server device of claim 4, wherein the one or more processors are further configured to:
receive, prior to expiration of the refresh timer, an additional bit stream corresponding to an additional spherical harmonic expansion model.

6. The server device of claim 1, wherein the bit stream comprises a Networked Transport of Radio Technical Commission For Maritime Services (RTCM) via Internet Protocol (NTRIP) bit stream.

7. The server device of claim 1, wherein the bit stream is received from a PPP server.

8. The server device of claim 1, wherein the at least one ionosphere coefficient is derived from the at least one measurement of ionosphere conditions.

9. The server device of claim 1, wherein the spherical harmonic expansion model comprises a vertical total electron content (VTEC) spherical harmonic expansion model.

10. The server device of claim 1, wherein the spherical harmonic expansion model is associated with a validity time that comprises an amount of time for which the at least one ionosphere coefficient can be used to correct for the at least one error in the at least one satellite signal.

11. The server device of claim 10, wherein the ionosphere file is distributed to user equipment (UE) according to a request timer.

12. The server device of claim 11, wherein the one or more processors are further configured to:
the request timer is greater than a refresh timer, the refresh timer comprising a duration of time between generating the at least one ionosphere coefficient and generating another ionosphere coefficient to update the at least one ionosphere coefficient; and
the request timer is less than the validity time.

13. The server device of claim 11, wherein the one or more processors are further configured to:
the request timer is 1 hour or less;
the refresh timer is 3 minutes or less; and
the validity time is 2 hours.

14. A server device comprising:
one or more processors configured to:
receive at least one ionosphere coefficient for at least one error in at least one satellite signal due to at least one ionospheric condition;
store the at least one ionosphere coefficient;
receive a request for updated ionosphere information; and
communicate, in response to the request, the at least one ionosphere coefficient.

15. The server device of claim 14, wherein the at least one ionosphere coefficient is associated with a validity time that comprises an amount of time for which the at least one ionosphere coefficient effective for correcting for the at least one error in the at least one satellite signal.

16. The server device of claim 15, wherein the at least one ionosphere coefficient corresponds to a vertical total electron content (VTEC) spherical harmonic expansion model.

17. The server device of claim 15, wherein:
the request is received according to a request timer,
the request timer is greater than a refresh timer, the refresh timer comprising a duration of time between generating the at least one ionosphere coefficient and generating another ionosphere coefficient to update the at least one ionosphere coefficient and
the request timer is less than the validity time.

18. The server device of claim 14, wherein the one or more processors are further configured to:
replace a current ionosphere coefficient with the at least one ionosphere coefficient.

19. A method, comprising:
communicating a request for ionosphere information in response to detecting at least one trigger associated with obtaining the ionospheric information;
receiving, in response to the request, at least one ionosphere coefficient for correcting at least one error in at least one satellite signal due to at least one ionospheric condition; and
determining a current geographic location by using the at least one ionosphere coefficient to correct the at least one error in the at least one satellite signal due to the at least one ionospheric condition.

20. The method of claim 19, further comprising:
initiating a request timer for requesting updated ionosphere information.
